(19) United States
(12) Patent Application Publication
(10) Pub. No.: US 2005/0261802 A1
(43) Pub. Date: Nov. 24, 2005

(54) Vending machine and article sale method for vending machine

(75) Inventors: Takayuki Akuzawa, Gunma-gun (JP); Isao Ishizaki, Isesaki-shi (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 11/132,230

(22) Filed: May 19, 2005

(30) Foreign Application Priority Data
May 20, 2004 (JP) 2004-150484

(51) Int. Cl. G06F 17/00

(52) U.S. Cl. 700/232

(57) ABSTRACT

A vending machine comprises a first memory device storing a article choice information including a plurality of item data capable of displaying in at least two languages; an image display device for displaying at least one item in a predetermined language; a language changing-over item for outputting a changing-over signal of a displaying language; and a control device for changing over the predetermined language of the at least one item displayed on the image display device to another language on the basis of selecting the selector switch matching the language changing-over item.

### BACKGROUND OF THE INVENTION

1. Field of the Invention

The present invention relates to a vending machine for selling articles including cup-contained beverages and an article sale method of a vending machine.

2. Description of the Related Art

There are various known vending machines each equipped with an image display device, such as a liquid crystal display (LCD) or a cathode ray tube (CRT), on its side facing customers. This image display device displays an article choice information necessary for choosing an article, including types of articles, taste-adjustments of the articles, and prices of the articles. A customer can purchase a desired article on the basis of the displayed article choice information.

Incidentally, the article choice information displayed on the conventional image display device is displayed in the language (hereinafter referred to as the first language) of the country in which the vending machine is located. However, this vending machine may be used by a customer who understands only some other language different from the first language. Therefore, in trying to use the vending machine whose image display device displays the article choice information in the first language, the customer who understands only some other language different from the first language would find difficulty to understand the article choice information displayed on the image display device, and accordingly to purchase the desired article.

### SUMMARY OF THE INVENTION

An object of the present invention is to provide a vending machine which allows not only customers understanding the language of the country in which the vending machine is located but also other customers who understand only some other language different from the language of the country in which the vending machine is located to easily purchase the desired articles.

In order to achieve the above object stated above, a vending machine according to the invention comprises a first memory device storing a first article choice information including a plurality of item data capable of displaying in at least two languages; an image display device for displaying at least one item in a predetermined language; language changing-over means for outputting a changing-over signal of a displaying language; and first control means for changing over the predetermined language of the at least one item displayed on the image display device to another language in response to the changing-over signal.

This vending machine can display diverse desired languages on the image display device according to the situation of sale. Therefore it is made easier for not only a prospective customer understanding the language of the country in which the vending machine is located but also other customer who understand only some other language than the language of the country in which the vending machine is located to purchase a desired article.

An article sale method for a vending machine according to the invention comprises the steps of displaying at least one item chosen from an article choice information on an image display device in a predetermined language; implementing a predetermined selling sequence in response to a selecting operation according to at least one item displayed on the image display device; and cutting any unnecessary step of the predetermined selling sequence according to contents of the selecting operation when implementing the predetermined selling sequence.

This article sale method of a vending machine has the step of implementing the selling sequence and the step of automatically cutting any unnecessary step of the selling sequence. The vending machine can display the flow of article purchasing actions in a way easier to understand. Moreover, the customer is enabled to purchase the desired article in less time and more easily.

The above-stated and other objects, features and advantages of the invention will become more apparent from the following description when taken in conjunction with the accompanying drawings.

### BRIEF DESCRIPTION OF THE DRAWINGS

FIG. 1 shows a front view of a vending machine according to the present invention;

FIG. 2 shows a front view of a display unit and a selector switch provided on the vending machine shown in FIG. 1;

FIG. 3 is a block diagram showing a control circuit for the vending machine shown in FIG. 1;

FIG. 4 is a flow chart of processing for a display change-over control means of the vending machine shown in FIG. 1;

FIG. 5(a) to FIG. 5(j) illustrate the display unit of the vending machine shown in FIG. 1;

FIG. 6 shows another front view of the display unit and the selector switch of the vending machine shown in FIG. 1;

FIG. 7 is a flow chart of processing for a language change-over control of the vending machine shown in FIG. 1;

FIG. 8 shows a front view of a modified example of the display unit and the selector switch of the vending machine shown in FIG. 1;

FIG. 9(a) and FIG. 9(b) show front views of a variation of the display unit of the vending machine shown in FIG. 1; and

FIG. 10 shows a front view of another modified example of the display unit and the selector switch of the vending machine shown in FIG. 1.

### DESCRIPTION OF THE PREFERRED EMBODIMENTS

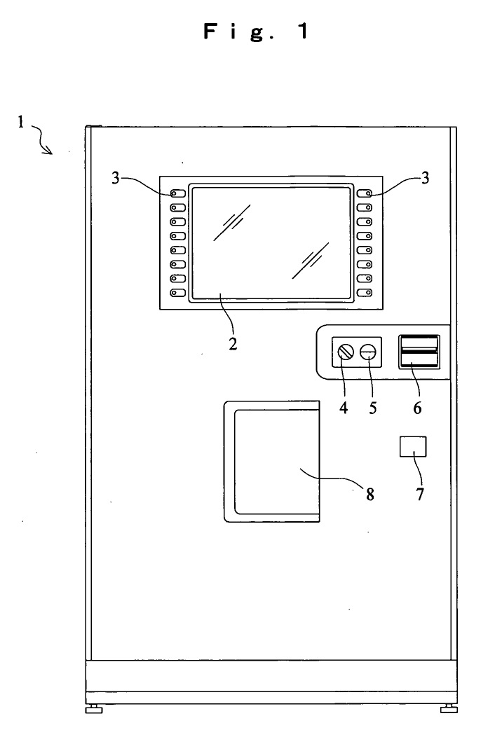

FIG. 1 to FIG. 10 shows a preferred embodiment of the present invention.

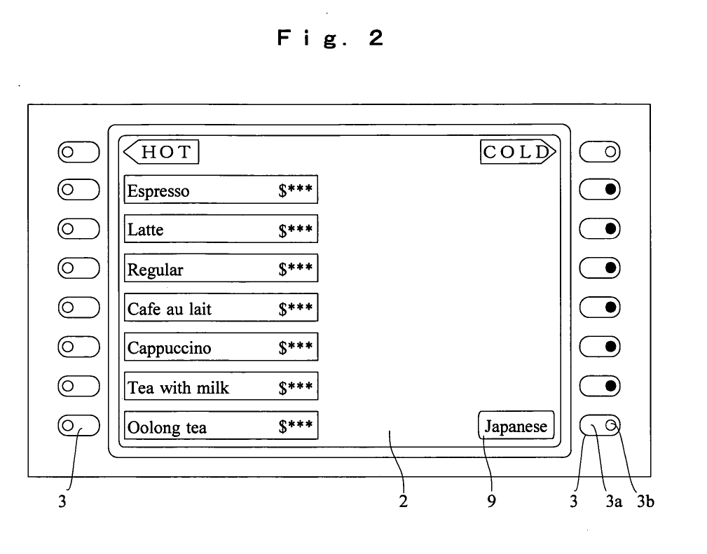

A constitution of a vending machine will be described with reference to FIG. 1 and FIG. 2. The front face of a vending machine 1 is provided with an image display device 2 for displaying an article choice information by at least one item, a plurality of selector switches 3 for selecting at least one of items of the article choice information, a return lever 4, a coin insert slot 5, a banknote insert slot 6, a coin return pocket 7 and an article reception pocket 8. The article choice information here includes types of articles, taste-adjustments of the articles, and prices of the articles.

The vending machine 1 is a vending machine for selling cup-contained beverages. This vending machine puts key materials with hot and cold water into a cup, stirs them, and provides a beverage as the article.

The image display device 2 displays any one of screens each showing the article choice information. A language to be initially displayed on the image display device 2 is the language of the country in which the vending machine 1 is located. Each screen includes a language changing-over item 9. Items showing the each screen correspond to selector switches 3 respectively.

Each selector switch 3 comprises a button 3a and a light-emitting diode (LED) 3b.

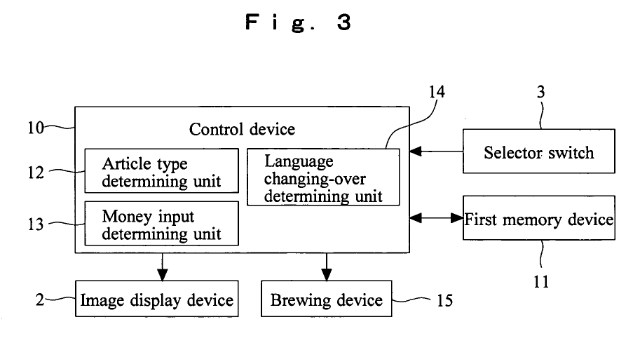

Next, a constitution of a control system of the vending machine shown in FIG. 1 and FIG. 2 will be described with reference to FIG. 3.

The vending machine 1 has a control device 10 and a first memory device 11 as shown in FIG. 3.

The control device 10 has an article type determining unit 12, a money input determining unit 13 and a language changing-over determining unit 14. This control device 10 performs language changing-over control of the image display device 2 and beverage brewing control of a brewing device 15.

The first memory device 11 stores the article choice information including a plurality of item data capable of displaying in at least two languages.

The article type determining unit 12 determines the type of article. The types of articles include a names of beverages which need no taste adjustment (e.g. carbonated drinks), a names of beverages which do need taste adjustment (e.g. coffee) and so on.

The money input determining unit 13 determines whether or not money has been put into the coin insert slot 5 and/or the banknote insert slot 6.

The language changing-over determining unit 14 determines whether or not the selector switch 3 corresponding to the language changing-over item 9 has pressed down.

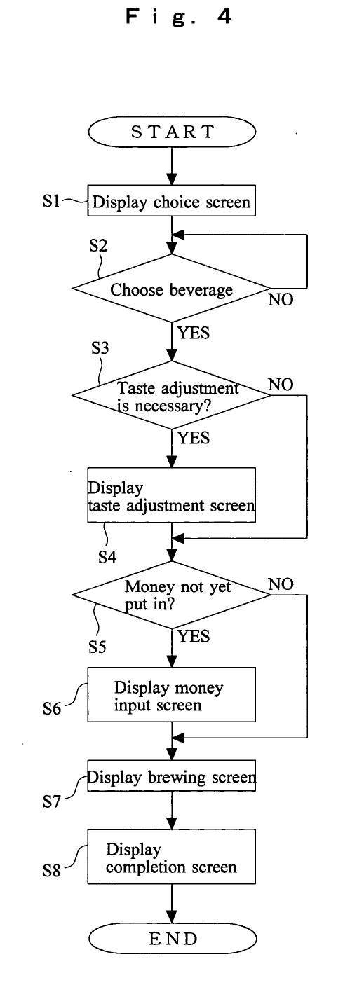

Next, control to change over the display on the image display device 2 (the article sale method for the vending machine 1) will be described with reference to FIG. 4.

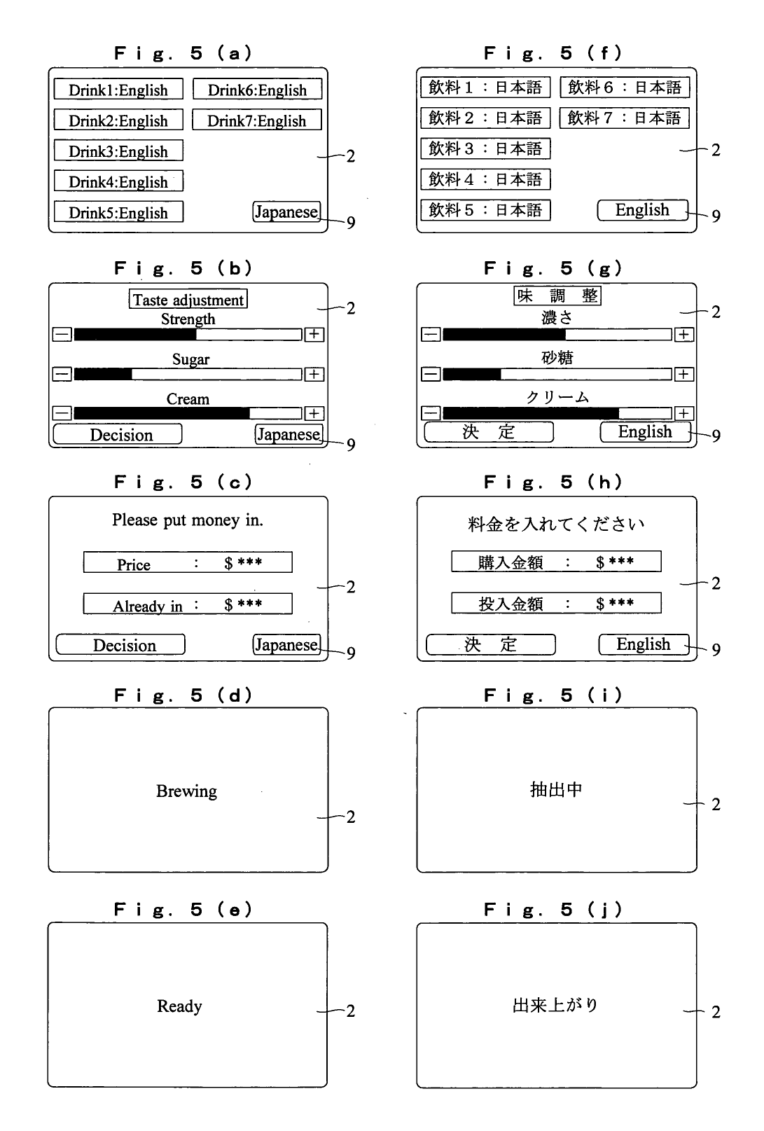

The initial screen of the image display device 2, as shown in FIG. 5(a), displays items for article choice, (sale awaiting state, step S1). The language displayed is the language (English in this embodiment) of the country in which the vending machine 1 is located.

At step S1, the control device 10 determines whether or not a customer has chosen any one of article types (step S2). After the control device 10 has determined at step S2 that the customer has chosen any one of article types, the article type determining unit 12 determines whether or not the chosen article needs taste adjustment (step S3). When the customer has not chosen any one of article types, the process returns to step S2.

At step S3, when the article type determining unit 12 determines that the article chosen by the customer needs taste adjustment, the image display device 2, as shown in FIG. 5(b), displays a taste adjustment screen including items for taste adjustment (step S4). The customer adjusts the taste as he or she desires with reference to this taste adjustment screen.

When the article type determining unit 12 determines that the article chosen by the customer needs no taste adjustment at step S3 or taste adjustment was completed at step S4, the money input determining unit 13 determines whether or not money has been put into the coin insert slot 5 and/or the banknote insert slot 6 (step S5).

At step S5, when the money input determining unit 13 determines that no money has been put into the coin insert slot 5 and/or the banknote insert slot 6, the image display device 2 displays a money input screen as shown in FIG. 5(c) (step S6). The customer puts in money in accordance with this money input screen.

When the money input determining unit 13 determines that sufficient money for buying the article has been put into the vending machine 1 at step S5 or the customer put in the required money at step S5, the image display device 2 displays a brewing screen as shown in FIG. 5(d) (step S7).

At step S7, the brewing device 15 starts brewing the article chosen by the customer. Upon completion of the brewing of the article, the image display device 2 displays a completion screen as shown in FIG. 5(e) (step S8). After that, the customer takes out the article from the article reception pocket 8.

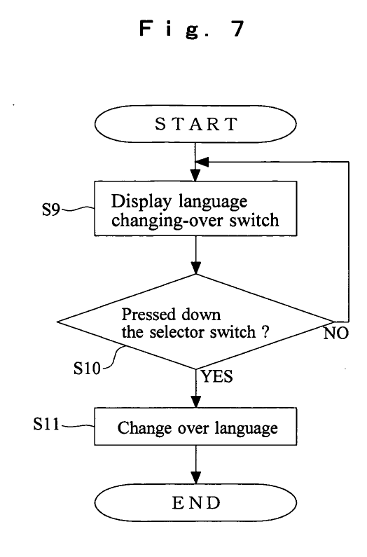

Next, language changing-over control will be described with reference of FIG. 7.

As shown in FIGS. 5(a) to 5(c), the image display device 2 displays the language changing-over item 9 (step S9). Then, the language changing-over determining unit 14 determines whether or not the customer has pressed down the selector switch 3 matching the language changing-over item 9 (step S10). At step S10, when the language changing-over determining unit 14 determines that the customer has pressed down the selector switch 3 matching the language changing-over item 9, the English language displayed on the image display device 2 changes over to the desired language (Japanese in this embodiment). At step S10, when the language changing-over determining unit 14 has determined that the customer has not pressed down the selector switch 3 matching the language changing-over item 9, the process returns to step S9.

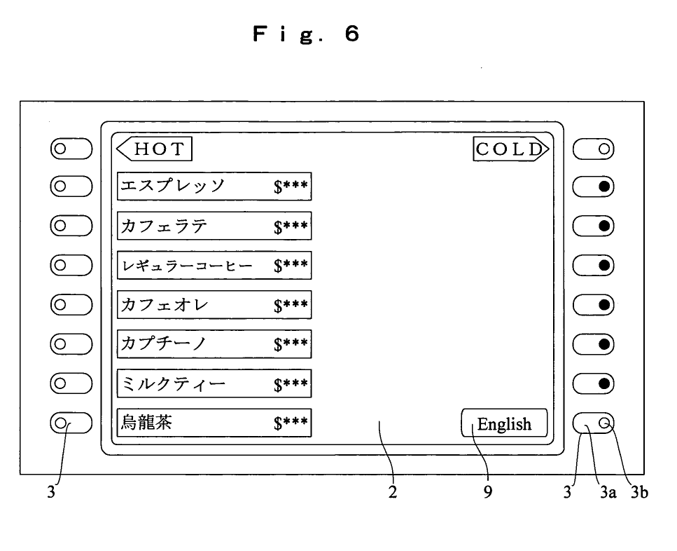

When the customer desires to change over the language displayed on the article choice screen shown in FIG. 5(a) from English to Japanese, the customer selects the selector switch 3 matching the language changing-over item 9 representing “Japanese”. This causes the article choice screen shown in FIG. 5(a) to be changed over to a screen written in Japanese as shown in FIG. 5(f) or FIG. 6.

When the customer desires to change over the language displayed on the taste adjustment screen shown in FIG. 5(b) from English to Japanese, the customer selects the selector switch 3 matching the language changing-over item 9 representing “Japanese”. This causes the taste adjustment screen shown in FIG. 5(b) to be changed over to a screen written in Japanese as shown in FIG. 5(g).

When the customer desires to change over the language displayed on the money input screen shown in FIG. 5(c) from English to Japanese, the customer selects the selector switch 3 matching the language changing-over item 9 representing “Japanese”. This causes the money input screen shown in FIG. 5(c) to be changed over to a screen written in Japanese as shown in FIG. 5(h).

Further, when the language displayed on the money input screen is Japanese, the brewing screen and the completion screen displays in Japanese as shown in FIGS. 5(i) and 5(j).

To add, when the language displayed on the image display device 2 is Japanese as shown in FIGS. 5(f) to 5(h), if the customer desires to change it over to English, he or she can press the selector switches 3 corresponding to the language changing-over item 9 marked “English”. Then the language displayed on the image display device 2 is changed over to English.

According to the vending machine 1 of this embodiment, it is possible to change over the language displayed on the image display device 2 to the desired language on the basis of selecting the selector switch 3 matching the language changing-over item 9 by the customer at the time of starting and on the way of purchasing operation. Therefore, not only the customers understanding the language of the country in which the vending machine 1 is located but also other customers understanding only some other language different from the language of the country of location can purchase the desired article more easily.

Further, the language changing-over item 9 is provided on any of the screens for article choice (FIGS. 5(a) and 5(f)), the taste adjustment screens (FIGS. 5(b) and 5(g)) and the money input screens (FIGS. 5(c) and 5(h)). This vending machine 1 thereby enables the customer to change-over the display language not only at the time of starting but also on the way of purchasing operation. Therefore, the vending machine 1 is accordingly made more convenient.

In the vending machine 1 of this embodiment, it is possible to implement its selling sequence by selection of the selector switches 3 on the basis of the article choice information including the language and image.

Further, the vending machine 1 can automatically cut any unnecessary step of the selling sequence, such as the screen-displaying, according to the type of the chosen article or whether and not money has been put in. The vending machine 1 is thereby enabled to display only the article choice information necessary for the customer. Therefore, the vending machine 1 can display the flow of article purchasing operations in a way easier to understand. Moreover, the customers are enabled to purchase the desired article in less time and more easily.

Although the image display device 2 as described above is supposed to display only the article choice information, this image display device 2 may also be equipped for displaying not only the article choice information but also a advertisements of a manufactures of articles, a advertisements of the articles themselves or some other graphic materials. Where such additional items are displayed, the image display device 2 can display the predetermined article choice information by the customer's operation to press at least one of the selector switches 3, to manipulate the return lever 4 or to put money into the coin insert slot 5 and/or the banknote insert slot 6.

The above-described image display device 2 is supposed to display different languages (English and Japanese in this embodiment) on mutually independent screens. However, the image display device 2 may as well display different languages in parallel. In this case, the image display device 2 need not display the language changing-over item 9.

Or, though the image display device 2 as described above is supposed to display only the languages matching the article choice information, this image display device 2 may as well display article images matching individual articles.

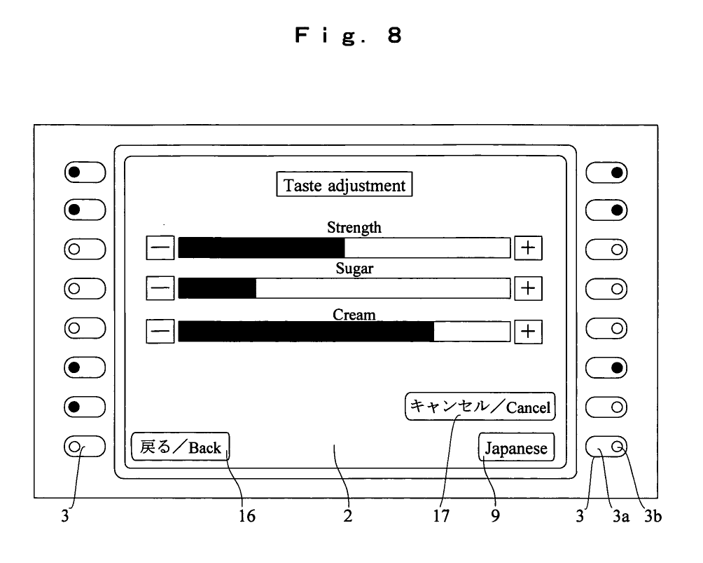

Also, the image display device 2 may also display as appropriate an item 16 marked “Back” as shown in FIG. 8. By pressing a selector switch 3 corresponding to this item 16, the image display device 2 can be switched back to the screen immediately before.

Further, the image display device 2 may also display as appropriate another item 17 marked “Cancel” as shown in FIG. 8. By pressing a selector switch 3 corresponding to this item 17, the image display device 2 is enabled to stop the procedure of article purchasing operation.

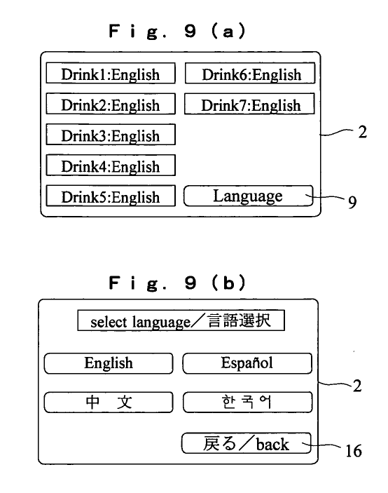

Also, though the above-described image display device 2 is supposed to display screens in only two languages (English and Japanese in this embodiment), this image display device 2 can be adapted to display the screens in a greater plurality of languages. In this case, the language changing-over item 9 displayed on the image display device 2 can be marked “Language” as shown in FIG. 9(a). When the customer selects the selector switch 3 corresponding this language changing-over item 9 marked “Language”, the screen is changed over to display a greater plurality of languages as shown in FIG. 9(b).

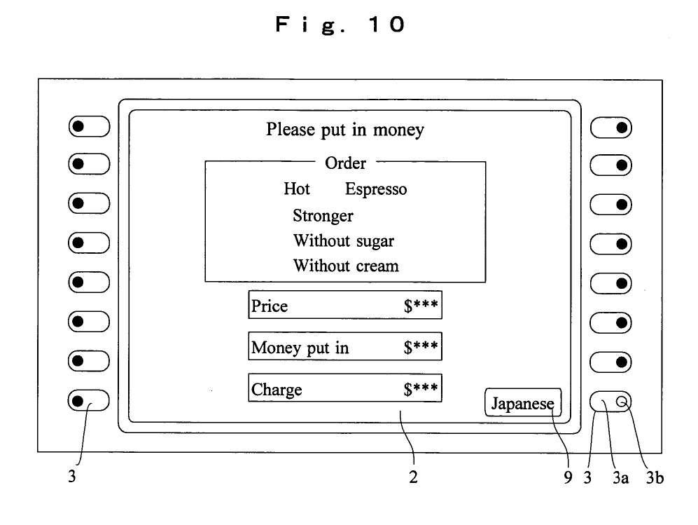

Further, the money input screen shown in FIG. 5(c) can as well display together the characteristics of the article selected before the money input screen, such as the temperature and taste of the article as shown in FIG. 10.

Also, the LED 3b constituting a part of each selector switch 3 may be a blue or red light emitting diode. By varying the color from one LED 3b to another, the temperature (hot or cold), taste and other characteristics of the article can be indicated. Further, only the LEDs 3b that can be pressed when choosing the article can be lit as shown in FIG. 2, FIG. 6, FIG. 8 and FIG. 10.

Further, the vending machine 1 may be provided with a second memory device storing a second article choice information including a plurality of item data capable of displaying in at least one different language from the at least two display languages stored in the first memory device 11 and second control for changing over the predetermined language of the at least one item displayed on the image display device 2 to another language different from the at least two language on the basis of selecting the selector switch 3 matching the language changing-over item 9 (not shown).

Further the first memory device or the second memory device may be a memory card.

Although this embodiment has been described with reference to the application of the control of the image display device 2 to a vending machine for selling cup-contained beverages, this present invention can be applied to any vending machine having the image display device 2, such as a serpentine type vending machine.

The preferred embodiment of the invention hitherto described in this specification is only illustrative but not restrictive. The scope of the invention is stated in the appended claims, and every modification that can be encompassed by those claims is to be included in the invention.

1. A vending machine comprising:
a first memory device storing a first article choice information including a plurality of item data capable of displaying in at least two languages;
an image display device for displaying at least one item in a predetermined language;
language changing-over means for outputting a changing-over signal of a displaying language; and
first control means for changing over the predetermined language of the at least one item displayed on the image display device to another language in response to the changing-over signal.

2. The vending machine according to claim 1, wherein:
the item data of the first article choice information corresponds to at least one of types of articles, taste-adjustments of the articles, and prices of the articles.

3. The vending machine according to claim 1, wherein:
the first memory device is a memory card.

4. The vending machine according to claim 1, further comprising:
a second memory device storing a second article choice information including a plurality of item data capable of displaying in at least one different language from the at least two languages; and
second control means for changing over the predetermined language of the at least one item displayed on the image display device to another language different from the at least two language in response to the changing-over signal.

5. The vending machine according to claim 4, wherein:
the item data of the second article choice information corresponds to at least one of types of articles, taste-adjustments of the articles, and prices of the articles.

6. The vending machine according to claim 4, wherein:
the second memory device is a memory card.

7. An article sale method for a vending machine, comprising the steps of:
displaying at least one item chosen from an article choice information on an image display device in a predetermined language;
implementing a predetermined selling sequence in response to a selecting operation according to at least one item displayed on the image display device; and
cutting any unnecessary step of the predetermined selling sequence according to contents of the selecting operation when implementing the predetermined selling sequence.

8. The vending machine according to claim 7, wherein:
the article choice information includes a plurality of item data corresponding to at least one of types of articles, taste-adjustments of the articles, and prices of the articles.
